(19) United States
(12) Patent Application Publication
(10) Pub. No.: US 2025/0346098 A1
(43) Pub. Date: Nov. 13, 2025

(54) Slide-Type Sun Visor Structure

(71) Applicants: HYUNDAI MOTOR COMPANY, Seoul (KR); KIA CORPORATION, Seoul (KR); Yong San Co., Ltd., Ulsan (KR)

(72) Inventors: Han Shin, Gyeonggi-do (KR); Kang Ho Joo, Gyeonggi-do (KR); Sang Hoon Lee, Gyeonggi-do (KR); Jin Kim, Gyeonggi-do (KR)

(73) Assignees: HYUNDAI MOTOR COMPANY, Seoul (KR); KIA CORPORATION, Seoul (KR); Yong San Co., Ltd., Ulsan (KR)

(21) Appl. No.: 18/933,502

(22) Filed: Oct. 31, 2024

(30) Foreign Application Priority Data
May 7, 2024 (KR) 10-2024-0059585

(51) Int. Cl. B60J 3/02

(52) U.S. Cl. CPC B60J 3/0234; B60J 3/0208; B60J 3/023; B60J 3/0282

(57) ABSTRACT

Disclosed is a slide-type sun visor structure including a sun visor stored in a side surface of a vehicle when not used and pulled out toward a windshield when used, and a slide assembly fixed to the side surface of the vehicle and having formed therein a storage box in which the sun visor is stored, wherein the storage box has formed therein a groove in a length direction, and wherein the sun visor rotates while moving along the groove in the slide assembly and then moves to a position corresponding to the windshield.

### CROSS-REFERENCE TO RELATED APPLICATION

This application claims, under 35 U.S.C. § 119 (a), the benefit of and priority to Korean Patent Application No. 10-2024-0059585, filed on May 7, 2024, the entire contents of which are incorporated herein by reference.

### TECHNICAL FIELD

The present disclosure relates to a slide-type sun visor structure, wherein the sun visor is used to block sunlight from entering a driver's field of vision. More particularly, the present disclosure relates to a sun visor structure to implement a sun visor capable of corresponding to a windshield area.

### BACKGROUND

A sun visor for a vehicle can be installed at the upper portion of the front windshield of the driver's or passenger's seat of the vehicle to prevent sunlight from blocking the driver's or passenger's view. The sun visor can have a main body, which is a light blocking plate having an extremely limited area and made of synthetic resin, and a folding mechanism fastened to the main body so as to allow the driver or passenger to manually move the main body up, down, left, or right to prevent sunlight from entering the field of vision.

Meanwhile, due to changes in the current mobility paradigm, there is a need for a sun visor capable of corresponding to a panoramic windshield to provide a maximized sense of openness when a driver sits in a driver's seat.

However, some sun visors are generally assembled to a roof rail using screws and then stored in a headlining. For this reason, when the sun visor is applied to a panoramic windshield, there are problems such as not being able to provide a roof rail and not being able to create a space in the headlining, which has been generally used to store the sun visor.

So as to solve said problems, a sun visor 10 may be capable of corresponding to an increase in windshield area by moving the sun visor 10 from the side to the front of the driver's seat and securing the sun visor 10 with a magnet to block sunlight as illustrated in FIG. 1. However, because the sun visor 10 is moved from the side to the front using a structure 20, the sun visor 10 interferes with the drivers head and is inconvenient for the driver to use. Furthermore, the sun visor 10 is only able to shade the front of the driver's seat and is disadvantageous in shading the side.

Moreover, some sun visors that correspond to the increase in windshield area have a problem of deterioration in appearance and marketability due to exposure of a rail portion mounted to the side surface of the vehicle.

The above information disclosed in this background section is only for enhancement of understanding of the background of the present disclosure, and therefore it may contain information that does not form the prior art that is already known to a person of ordinary skill in the art.

### SUMMARY

The present disclosure has been made in an effort to solve the above-described problems associated with the prior art, and an object of the present disclosure is to provide a sun visor capable of corresponding to an increase in windshield area.

Another object of the present disclosure is to provide a sun visor that does not interfere with a driver's head.

Another object of the present disclosure is to provide a sun visor capable of blocking sunlight from the front of the vehicle and also from the side of the vehicle.

Another object of the present disclosure is to prevent a problem of deterioration in appearance and marketability due to exposure of a rail portion mounted to the side surface of the vehicle.

The objects of the present disclosure are not limited to the foregoing, and other objects of the present disclosure not mentioned herein may be understood based on the following description, and may be understood more clearly through the embodiments of the present disclosure. In addition, the objects of the present disclosure may be realized by means and combinations thereof indicated in the claims.

So as to achieve objects of the present disclosure, provided is a slide-type sun visor structure including following configurations.

According to an embodiment of the present disclosure, a slide-type sun visor structure may include a sun visor stored in a side surface of a vehicle when not used and pulled out toward a windshield when used, and a slide assembly fixed to the side surface of the vehicle and having formed therein a storage box in which the sun visor is stored, wherein the storage box may have formed therein a groove in a length direction, and the sun visor may rotate while moving along the groove in the slide assembly and then move to a position corresponding to the windshield.

According to an embodiment of the present disclosure, the slide assembly may include a rail fixed to the side surface of the vehicle, a slot screen assembled to the upper surface of the rail and configured to prevent exposure of the rail, and a cover having formed therein a storage box to store the sun visor and having formed therein a groove in a length direction.

According to an embodiment of the present disclosure, the rail may include a ball screw positioned in the length direction of the sun visor, a slide retainer configured to move along the outer circumferential surface of the ball screw and coupled to the sun visor, and a rotary link configured to rotate the sun visor. Here, the slide retainer may push the sun visor toward the windshield while moving along the outer circumferential surface of the ball screw, and the rotary link coupled to the sun visor may rotate to move the sun visor toward the windshield.

According to an embodiment of the present disclosure, the slide retainer may include an insertion member coupled to the sun visor, and the insertion member may axially rotate along with the movement of the sun visor.

According to an embodiment of the present disclosure, the slot screen may include at least one upper plate and at least one lower plate. Here, the upper plate and the lower plate may be positioned to be spaced apart from each other by a predetermined distance and the slide retainer of the rail may slide through the space between the upper plate and the lower plate, the upper plate and the lower plate each may have a spring placed at the lower portion thereof, and when the sun visor slides, the upper plate and the lower plate may be pushed in directions away from the space to thereby compress the spring.

According to an embodiment of the present disclosure, the spring provided may be a plurality of springs, and may be placed at the lower portion of the upper plate and at the lower portion of the lower plate.

According to an embodiment of the present disclosure, the sun visor may have one end at which a steel plate is placed, and an electromagnet module mounted to the ceiling of the vehicle may allow the sun visor to be secured on the ceiling of the vehicle.

According to an embodiment of the present disclosure, the steel plate may be attached to or released from the electromagnet module by magnetism.

According to an embodiment of the present disclosure, the slide assembly may be provided as a manual slide assembly in which a driver him or herself pulls out the sun visor.

According to a different embodiment of the present disclosure, the slide assembly may be provided as an automatic slide assembly configured to operate by an electric signal.

Here, the rail of the slide assembly according to the different embodiment of the present disclosure may further include an operating motor configured to rotate the ball screw, and, when the operating motor rotates a coupling, the ball screw coupled to the coupling may rotate to move the slide retainer forward.

According to an embodiment of the present disclosure, the side surface of the vehicle may be provided with a limited switch mounted thereto, and the limited switch may be brought into contact with the slide retainer.

According to an embodiment of the present disclosure, the sun visor may include a pad being stored in the storage box in the slide assembly and to which at least one or more members are coupled, a screen member configured to cover the upper surface of the pad and to block sunlight, and a mirror configured to cover the upper surface of the screen member. Here, the pad, the screen member, and the mirror may be provided with at least one or more magnets, allowing the pad, the screen member, and the mirror to be attachable and detachable.

Other aspects and preferred embodiments of the present disclosure are discussed infra.

It is to be understood that the term “vehicle” or “vehicular” or other similar terms as used herein are inclusive of motor vehicles in general, such as passenger automobiles including sport utility vehicles (SUV), buses, trucks, various commercial vehicles, watercraft including a variety of boats and ships, aircraft, and the like, and include hybrid vehicles, electric vehicles, plug-in hybrid electric vehicles, hydrogen-powered vehicles, and other alternative fuel vehicles (e.g., fuels derived from resources other than petroleum). As referred to herein, a hybrid vehicle is a vehicle that has two or more sources of power, for example, a vehicle powered by both gasoline and electricity.

The above and other features of the present disclosure are discussed herein.

### BRIEF DESCRIPTION OF THE DRAWINGS

The above and other features of the present disclosure will now be described in detail with reference to certain exemplary embodiments thereof illustrated in the accompanying drawings which are given hereinbelow by way of illustration only, and thus are not limitative of the present disclosure, and wherein:

FIG. 1 illustrates a sun visor and a sun visor structure of the prior art;

FIG. 2 is a schematic view of a slide-type sun visor structure according to an embodiment of the present disclosure;

FIG. 3 is a detailed view of the slide-type sun visor structure according to an embodiment of the present disclosure;

FIG. 4 is a detailed view of a slide assembly according to an embodiment of the present disclosure;

FIG. 5 is a detailed view of the slide assembly according to an embodiment of the present disclosure;

FIGS. 6A, 6B, and 6C are sequential views showing how the sun visor is manually rotated in the slide assembly of the present disclosure;

FIGS. 7A, 7B, and 7C are sequential views showing how the sun visor is automatically rotated in the slide assembly of the present disclosure;

FIG. 8 is a view illustrating a slide retainer and a limited switch of the present disclosure being brought into contact with each other;

FIG. 9 is a view illustrating a slot screen of the slide assembly of the present disclosure;

FIG. 10 is a cross-sectional view of FIG. 9 taken along the line A-A;

FIG. 11 is a view illustrating a pad of the sun visor and an electromagnet module according to an embodiment of the present disclosure being brought into contact with each other;

FIG. 12A is a view illustrating a steel plate of the pad according to an embodiment of the present disclosure;

FIG. 12B is a view of the electromagnet module according to an embodiment of the present disclosure; and

FIG. 13 is a view illustrating the sun visor according to an embodiment of the present disclosure.

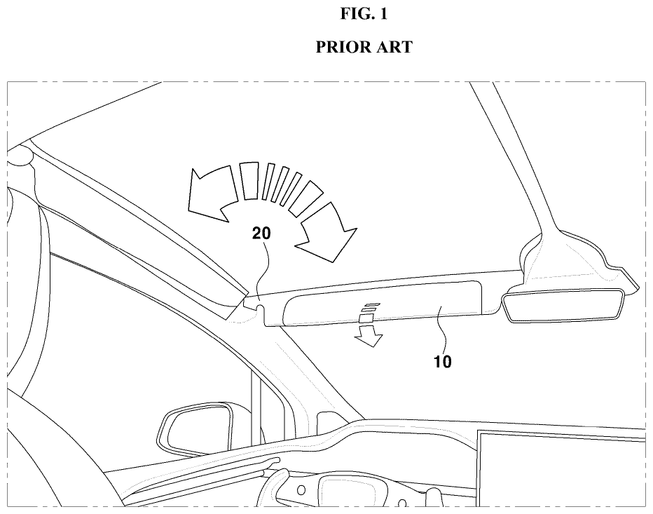

It should be understood that the appended drawings are not necessarily to scale, presenting a somewhat simplified representation of various preferred features illustrative of the basic principles of the present disclosure. The specific design features of the present disclosure, including, for example, specific dimensions, orientations, locations, and shapes, will be determined in part by the particular intended application and usage environment.

In the figures, the reference numbers refer to the same or equivalent parts of the present disclosure throughout the several figures of the drawing.

### DETAILED DESCRIPTION

Hereinafter, embodiments of the present disclosure is described in detail with reference to the accompanying drawings. The embodiments of the present disclosure may be modified into various forms, and the scope of the present disclosure should not be construed as being limited to the following embodiments. The embodiments are provided to more completely explain the present disclosure to those skilled in the art.

In addition, terms such as “portion,” “nit,” “module,” etc. used in this specification each refer to a unit that processes at least one function or operation, and may be implemented as hardware, software or a combination thereof.

The terminology used herein is for the purpose of describing particular embodiments and is not intended to be limiting. A singular representation may include a plural representation unless it represents a definitely different meaning from the context.

In the description and claims of the present disclosure, directions such as up, down, left and right (or sides), front, back, etc. are determined based on the relative positions in the drawings or the relative positions among the components for the convenience of explanation, not for the purpose of limiting rights. Therefore, each direction described below is based on this principle, except in cases where it is specifically limited otherwise.

Hereinafter, an embodiment will be described in detail with reference to the accompanying drawings, and in the description given with reference to the accompanying drawings, the same or corresponding components are assigned the same reference numerals, and a description thereof will not be repeated.

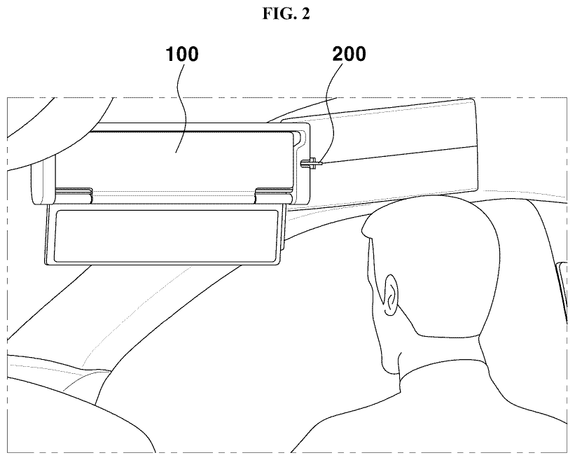

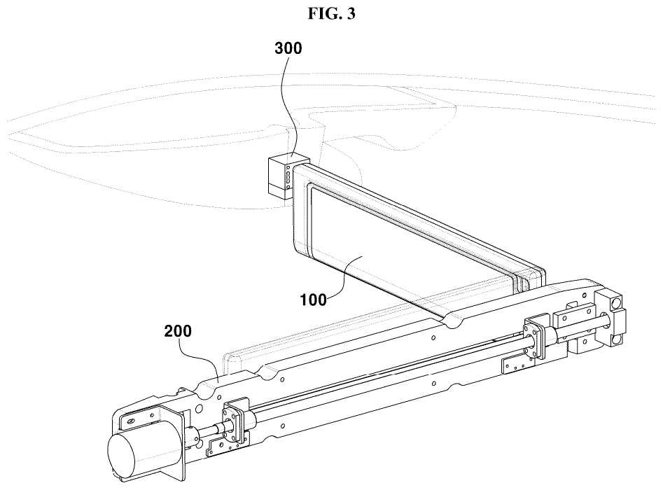

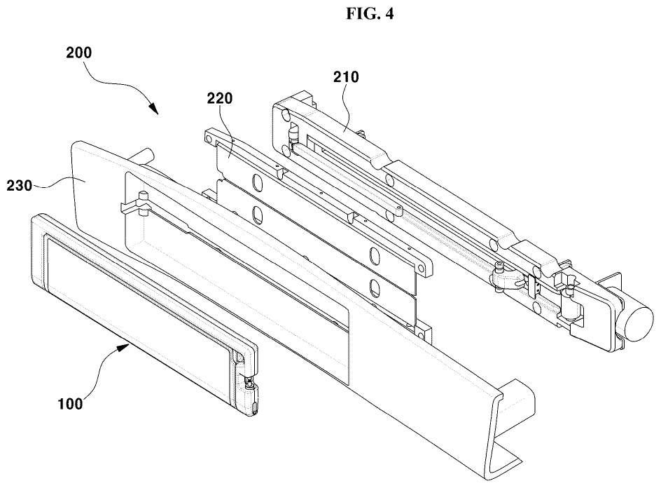

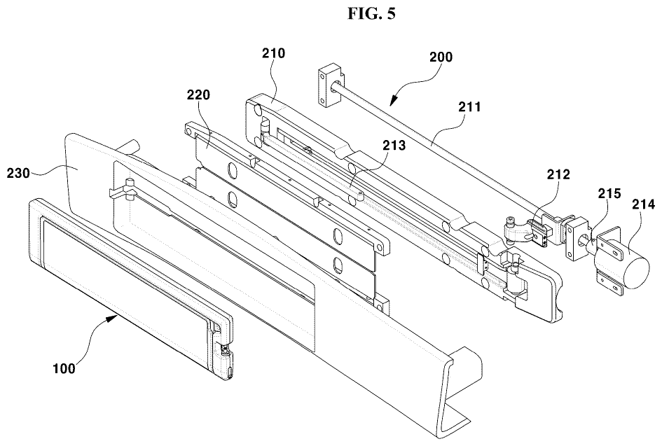

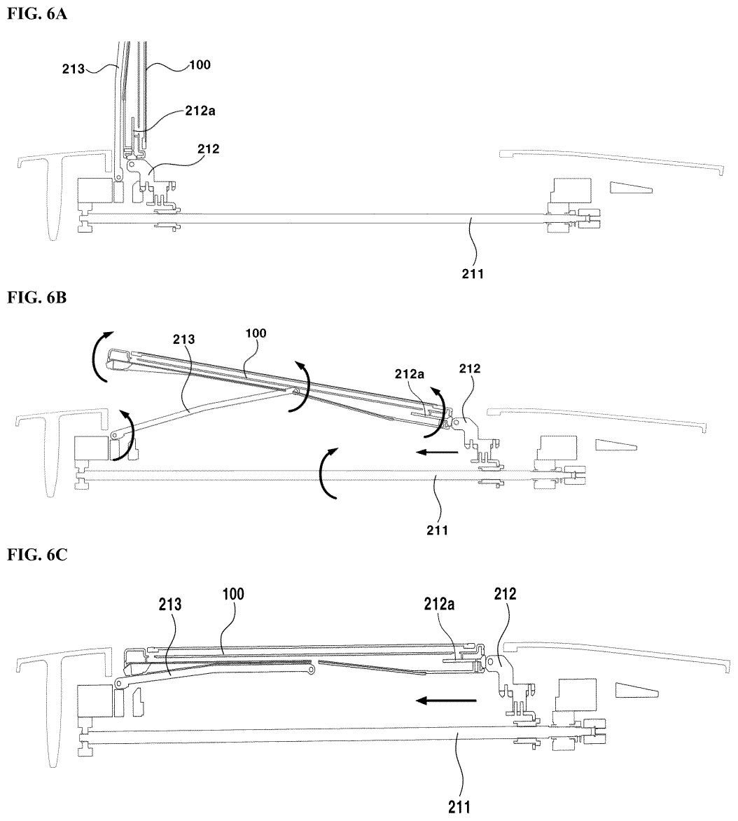

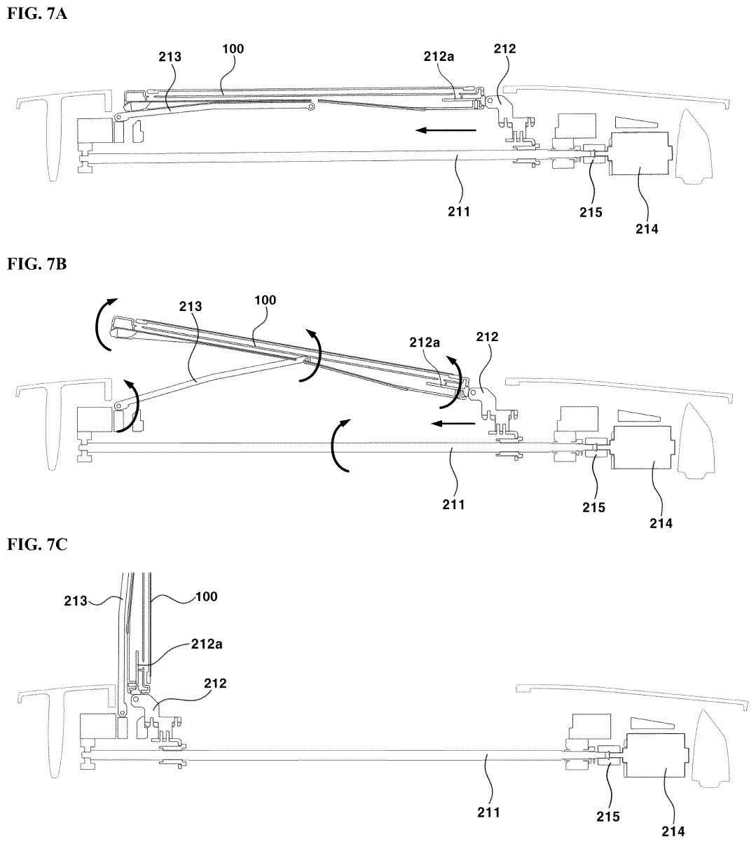

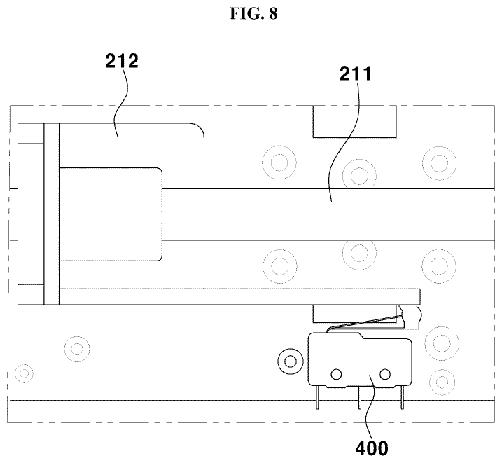

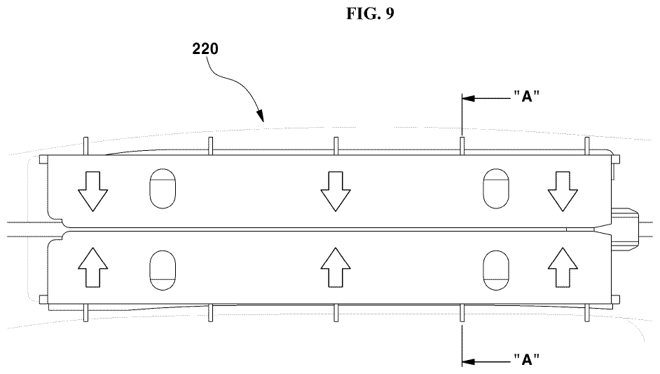

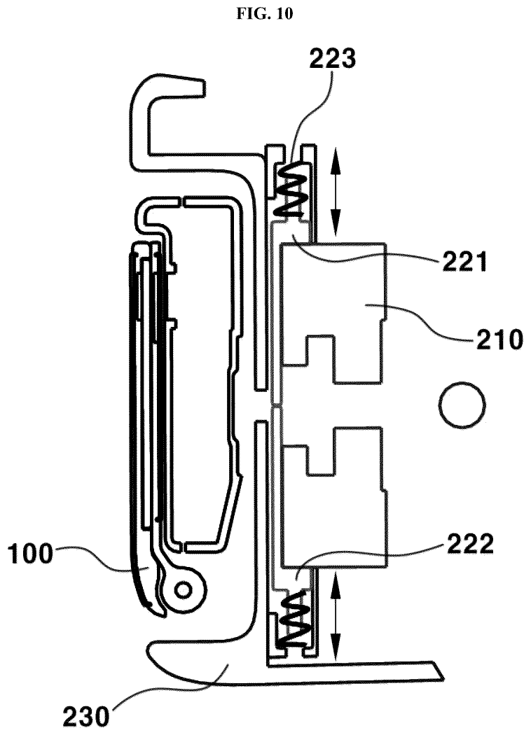

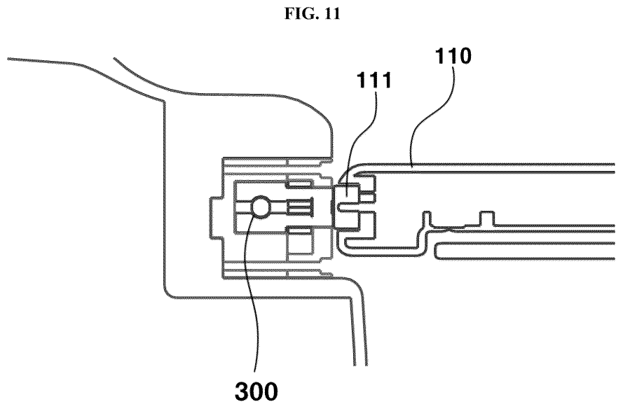

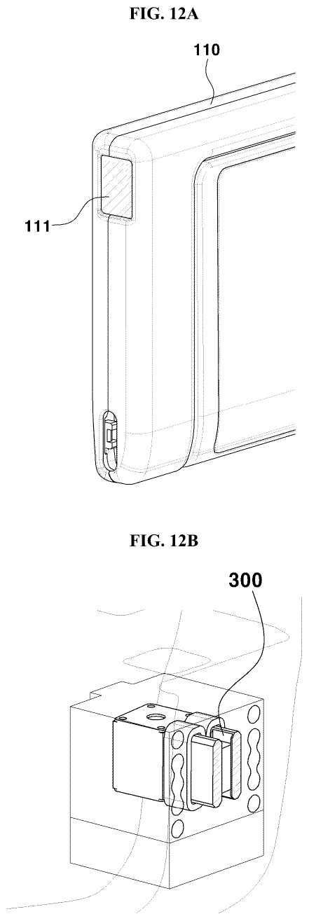

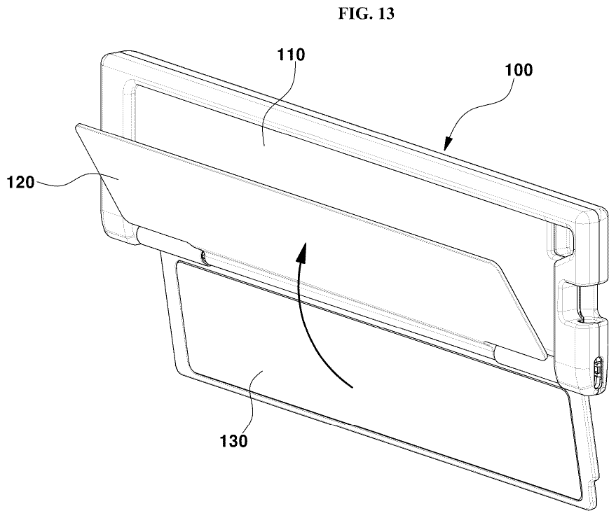

FIG. 2 is a schematic view of a slide-type sun visor structure according to an embodiment of the present disclosure, FIG. 3 is a detailed view of the slide-type sun visor structure according to an embodiment of the present disclosure, FIG. 4 is a detailed view of a slide assembly according to an embodiment of the present disclosure, FIG. 5 is a detailed view of the slide assembly according to an embodiment of the present disclosure, FIGS. 6A, 6B, and 6C are sequential views showing how the sun visor is manually rotated in the slide assembly of the present disclosure, FIGS. 7A, 7B, and 7C are sequential views showing how the sun visor is automatically rotated in the slide assembly of the present disclosure, FIG. 8 is a view illustrating a slide retainer and a limited switch of the present disclosure being brought into contact with each other, FIG. 9 is a view illustrating a slot screen of the slide assembly of the present disclosure, FIG. 10 is a cross-sectional view of FIG. 9, FIG. 11 is a view illustrating a pad of the sun visor and an electromagnet module according to an embodiment of the present disclosure being brought into contact with each other, FIG. 12A is a view illustrating a steel plate of the pad according to an embodiment of the present disclosure, FIG. 12B is a view illustrating the electromagnet module according to an embodiment of the present disclosure, and FIG. 13 is a view illustrating the sun visor according to an embodiment of the present disclosure.

Referring to FIG. 2 through FIG. 5, a slide-type sun visor structure according to an embodiment of the present disclosure includes a sun visor 100, a slide assembly 200, and an electromagnet module 300.

The sun visor 100 of the slide-type sun visor structure of the present disclosure includes a pad 110, a screen member 120, and a mirror 130 (see FIG. 13). The sun visor pad 110 is stored in a cover 230 of the slide assembly 200, which will be described later. Specific components of the sun visor 100 of the present disclosure will be described in detail with reference to FIG. 13.

The slide assembly 200 according to an embodiment of the present disclosure is implemented in a structure in which the slide assembly 200 is fixed to a side surface of a vehicle, the sun visor 100 is stored in a storage box, and the storage box has formed therein a groove for guiding the sun visor 100 in a length direction to thereby allow the sun visor 100 to be drawn out while rotating along the groove. Specifically, the slide assembly 200 of the present disclosure includes a rail 210, a slot screen 220, and the cover 230 to thereby allow the sun visor 100 to linearly move to the front of the vehicle and then rotate to move to a position corresponding to a windshield.

The rail 210 of the slide assembly of the present disclosure is fixed to the side surface of the vehicle, has formed therein a continuous groove in a length direction to allow a slide movement, and includes a ball screw 211, a slide retainer 212, and a rotary link 213. Here, the continuous groove is a groove through which the slide retainer 212, to be described later, slides to thereby move the sun visor 100 coupled to the slide retainer 212. The slot screen 220, to be described later, and the cover 230 each may also have formed therein a continuous groove at the same position as the continuous groove in the rail 210.

Meanwhile, in the rail 210 of the present disclosure including the ball screw 211, the slide retainer 212, and the rotary link 213, the ball screw 211 of the rail is disposed in the length direction of the sun visor 100, has an outer circumferential surface to which the slide retainer 212 is coupled, and, depending on the implementation, rotates to move the slide retainer 212.

The slide retainer 212 of the rail of the present disclosure is coupled to the outer circumferential surface of the ball screw 211, and is configured to move the sun visor 100 linearly and rotationally while moving along the outer circumferential surface of the ball screw 211. Specifically, the slide retainer 212 may further include an insertion member 212a. The insertion member 212a is coupled to the sun visor 100, and also axially rotates toward the windshield by the rotation of the rotary link 213, which is to be described later.

The rotary link 213 of the rail of the present disclosure serves to rotate the sun visor 100 in a vertical direction. Here, the slide retainer 212 pushes the sun visor 100 toward the windshield, and the rotary link 213 rotates to vertically move the sun visor 100 coupled to the rotary link 213.

Meanwhile, the slide assembly of the present disclosure may be operated automatically or manually.

FIGS. 6A, 6B, and 6C and FIGS. 7A, 7B, and 7C explain the automatic or manual withdrawal of the sun visor from the slide assembly, as illustrated in FIGS. 6A, 6B, and 6C, a manual slide assembly 200 does not include an operating motor 214 nor a coupling 215, but allows the sun visor 100 to be pulled out by the action of the driver pulling out the sun visor 100 from the storage box in the slide assembly 200. Moreover, when the user stops the action of withdrawal, the sun visor 100 also stops moving.

Specifically, by the action of the driver pulling out the sun visor 100 from the storage box, the slide retainer 212 coupled to the outer circumferential surface of the ball screw 211 is moved forward, the insertion member 212a of the slide retainer pushes the sun visor 100 forward, and at the same time, the rotary link 213 coupled to the sun visor 100 vertically rotates the sun visor 100 to thereby move the sun visor 100 toward the windshield.

As illustrated in FIGS. 7A, 7B, and 7C, an automatic slide assembly 200 includes an operating motor 214 and a coupling 215.

The operating motor 214 is coupled to one end of the ball screw 211 and is configured to operate when receiving an electric signal. Specifically, when the operating motor 214 operates, the coupling 215 and the ball screw 211 coupled to the operating motor 214 rotate. By the rotation of the ball screw 211, the slide retainer 212 operates, and the rotary link 213 and a sun visor hinge rotate at the same time. The slide retainer 212 moves forward, and the sun visor 100 also moves while axially rotating. Thereafter, the slide retainer 212 is brought into contact with a limited switch 400, and a stop signal may be transmitted to the operating motor 214 of the slide assembly and to the electromagnet module 300, to be described later.

FIG. 8 is a view illustrating the slide retainer 212 and the limited switch 400 of the present disclosure being brought into contact with each other. In the manual slide assembly 200, when the slide retainer 212 is brought into contact with the limited switch 400, an electromagnetic operating signal is transmitted to the electromagnet module 300.

Meanwhile, in the automatic slide assembly 200, when the slide retainer 212 is brought into contact with the limited switch 400, the operating motor 214 stops operating, the coupling 215 and the ball screw 211 stop rotating, and the rotary link 213 and the slide retainer 212 also stop rotating. Like the manual slide assembly, the automatic slide assembly 200 transmits an electromagnetic operating signal to the electromagnet module 300.

FIG. 9 is a view illustrating the slot screen of the slide assembly of the present disclosure, and FIG. 10 is a cross-sectional view of FIG. 9 taken along the line A-A. Hereinafter, the slot screen of the slide assembly will be described with reference to FIG. 9 and FIG. 10.

The slot screen 220 of the slide assembly according to an embodiment of the present disclosure is assembled to an upper surface of the rail 210 and includes at least one upper plate 221 and at least one lower plate 222. The upper plate 221 and the lower plate 222 are positioned to be spaced apart from each other by a predetermined distance, and the sun visor 100 slides through the space between the upper plate 221 and the lower plate 222. The upper plate 221 and the lower plate 222 each have a spring 223 placed at the lower portion thereof, and when the sun visor 100 slides, the upper plate 221 and the lower plate 222 are pushed in directions away from the space to thereby compress the spring 223.

Specifically, the sun visor 100 is stably stored in the storage box by the spring 223 placed at each of the upper plate 221 and the lower plate 222 of the slot screen 220 in the slide assembly. While withdrawing the sun visor 100, the insertion member 212a of the slide retainer moves through the space between the upper plate 221 and the lower plate 222 to widen the space, compressing the spring 223 placed at each of the upper plate 221 and the lower plate 222. Therefore, the space is open only when the insertion member 212a of the slide retainer slides therethrough, and when the sun visor 100 is stored or finishes rotating, the space is closed to prevent exposure of the rail 210.

As such, the slot screen 220 may prevent the groove in the slide assembly from being exposed, solving the problem of deterioration in appearance and marketability.

The cover 230 of the slide assembly according to an embodiment of the present disclosure has formed therein the storage box to store the sun visor 100, and has formed therein a continuous groove in the length direction. The sun visor 100 is pulled out while the insertion member 212a of the slide retainer slides through the groove in the cover 230.

FIG. 11 is a view illustrating the pad of the sun visor and the electromagnet module according to an embodiment of the present disclosure being brought into contact with each other, FIG. 12A is a view illustrating a steel plate of the pad according to an embodiment of the present disclosure, and FIG. 12B is a view illustrating the electromagnet module according to an embodiment of the present disclosure.

Referring to FIG. 11 and FIGS. 12A and 12B, the electromagnet module 300 of the present disclosure is mounted on the ceiling of the vehicle and is electrically coupled to a steel plate 111 of the sun visor pad 110, which will be described later.

The electromagnet module 300 of the present disclosure operates when receiving an operation signal from the manual slide assembly or from the automatic slide assembly. Specifically, the electromagnet module 300 secures or releases the sun visor 100 by generating magnetic force by current or by losing magnetic force and returning to its original state when current is cut off.

For example, when a normal signal pulse is transmitted, magnetism is maintained and the sun visor 100 is secured on the ceiling of the vehicle. Conversely, when a reverse signal pulse is transmitted, the magnetism is released to allow the sun visor 100 to move.

Meanwhile, the pad 110 of the sun visor to be described later has one end to which the steel plate 111 is mounted. The steel plate 111 maintains or releases magnetism with or from the pad 110 of the sun visor.

FIG. 13 is a view illustrating the sun visor according to an embodiment of the present disclosure. The sun visor 100 of the present disclosure is stored in the side surface of the vehicle and is moved to correspond to the windshield when used, and has structure in which the pad 110, the screen member 120, and the mirror 130 are combined with one another. Moreover, the pad 110, the screen member 120, and the mirror 130 may be fixed using magnets.

As described above, the pad 110 of the sun visor 100 according to an embodiment of the present disclosure is provided with the steel plate 111 at one end thereof to generate magnetism interacting with the electromagnet module 300, and may have the same shape as the storage box so as to be stably stored therein. The inner side of the pad 110 is provided with a magnet, so that the pad 110 is coupled to the screen member 120, to be described later, by magnetism.

The screen member 120 of the sun visor 100 of the present disclosure covers the upper surface of the pad 110, blocks sunlight, and covers the front surface of the mirror 130 when the mirror 130 is not used. Meanwhile, the screen member 120 may be moved to the upper surface of the pad 110 when the driver uses the mirror 130, and may cover the mirror 130 when the driver does not use the mirror 130. As such, the sun visor 100 may be implemented to be a variable structure, which may be used as a sunshade by using the screen member 120 to block sunlight from the side and also may be used as a mirror.

Meanwhile, because the mirror 130 of the present disclosure is a mirror generally used in the sun visor 100, a description therefor will be omitted.

As described above, the combination structure of the slide assembly 200 of the present disclosure allows the sun visor 100 to correspond to the increase in windshield area due to changes in mobility paradigm, and implements a slide-type sun visor structure in which the protrusion of the sun visor 100 does not interfere with a driver's head. Moreover, there may be provided a slide-type sun visor structure capable of blocking sunlight from the front of the vehicle and also from the side of the vehicle. Lastly, a driver may use the sun visor 100 as a mirror 130 and also as a sunshade by covering the mirror 130 with the screen member 120 when needing shade.

As is apparent from the above description, the present disclosure may obtain following effects by the configuration, combination, and operation relationship described above with the present embodiment.

The present disclosure may provide a sun visor capable of corresponding to the increase in windshield area.

Moreover, the present disclosure may provide a sun visor that does not interfere with a driver's head.

Furthermore, the present disclosure may provide a sun visor capable of blocking sunlight from the front of the vehicle and also from the side of the vehicle.

Lastly, the present disclosure may prevent a problem of deterioration in appearance and marketability due to exposure of a rail portion mounted to the side surface of the vehicle.

Although the present disclosure has been described in connection with specific limitations such as detailed components as well as limited embodiments and drawings, these are merely provided to aid general understanding of the present disclosure. The present disclosure is not limited to the above embodiments, and those skilled in the art will appreciate that various changes and modifications are possible from the above description.

The present disclosure is thus not limited to the example embodiments described above, and rather intended to include the following appended claims, and all modifications, equivalents, and alternatives falling within the spirit and scope of the following claims.

What is claimed is:

1. A slide-type sun visor structure, comprising:
a sun visor stored in a side surface of a vehicle when not used and pulled out toward a windshield when used; and
a slide assembly fixed to the side surface of the vehicle and having formed therein a storage box in which the sun visor is stored, wherein the storage box has formed therein a groove in a length direction,
wherein the sun visor rotates while moving along the groove in the slide assembly and then moves to a position corresponding to the windshield.

2. The slide-type sun visor structure of claim 1, wherein the slide assembly comprises:
a rail fixed to the side surface of the vehicle;
a slot screen assembled to an upper surface of the rail and configured to prevent exposure of the rail; and
a cover having formed therein a storage box to store the sun visor and having formed therein a groove in a length direction.

3. The slide-type sun visor structure of claim 2, wherein the rail comprises:
a ball screw positioned in the length direction of the sun visor;
a slide retainer configured to move along an outer circumferential surface of the ball screw and coupled to the sun visor; and
a rotary link configured to rotate the sun visor, and
wherein the slide retainer pushes the sun visor toward the windshield while moving along the outer circumferential surface of the ball screw, and the rotary link coupled to the sun visor rotates to move the sun visor toward the windshield.

4. The slide-type sun visor structure of claim 3, wherein
the slide retainer comprises an insertion member coupled to the sun visor, and
the insertion member axially rotates along with movement of the sun visor.

5. The slide-type sun visor structure of claim 3, wherein the slot screen comprises at least one upper plate and at least one lower plate, and
wherein the upper plate and the lower plate are positioned to be spaced apart from each other by a predetermined distance and the slide retainer of the rail slides through the space between the upper plate and the lower plate, the upper plate and the lower plate each have a spring placed at a lower portion thereof, and when the sun visor slides, the upper plate and the lower plate are pushed in directions away from the space to thereby compress the spring.

6. The slide-type sun visor structure of claim 5, wherein the spring provided is a plurality of springs, and placed at a lower portion of the upper plate and at a lower portion of the lower plate.

7. The slide-type sun visor structure of claim 1, wherein the sun visor has one end at which a steel plate is placed, and an electromagnet module mounted to a ceiling of the vehicle allows the sun visor to be secured on the ceiling of the vehicle.

8. The slide-type sun visor structure of claim 7, wherein the steel plate is attached to or released from the electromagnet module by magnetism.

9. The slide-type sun visor structure of claim 1, wherein the slide assembly is provided as a manual slide assembly in which a driver him or herself pulls out the sun visor.

10. The slide-type sun visor structure of claim 1, wherein the slide assembly is provided as an automatic slide assembly configured to operate by an electric signal.

11. The slide-type sun visor structure of claim 3, wherein
the rail further comprises an operating motor configured to rotate the ball screw, and
when the operating motor rotates a coupling, the ball screw coupled to the coupling rotates to move the slide retainer forward.

12. The slide-type sun visor structure of claim 4, wherein
the side surface of the vehicle is provided with a limited switch mounted thereto, and
the limited switch is brought into contact with the slide retainer.

13. The slide-type sun visor structure of claim 1, wherein the sun visor comprises:
a pad being stored in the storage box in the slide assembly and to which at least one or more members are coupled;
a screen member configured to cover an upper surface of the pad and to block sunlight; and
a mirror configured to cover an upper surface of the screen member, and
wherein the pad, the screen member, and the mirror are provided with at least one or more magnets, allowing the pad, the screen member, and the mirror to be attachable and detachable.
